(19) United States
(12) Patent Application Publication
(10) Pub. No.: US 2002/0181845 A1
(43) Pub. Date: Dec. 5, 2002

(54) Optical transmission network for self-directed messages

(76) Inventors: Manfred R. Kuehnle, New London, NH (US); Hermann Statz, Wayland, MA (US); Theodore L. Simis, Inglewood, FL (US)

Correspondence Address: CESARI AND MCKENNA, LLP, 88 BLACK FALCON AVENUE, BOSTON, MA, 02210, US

(21) Appl. No.: 09/997,590

(22) Filed: Nov. 29, 2001

Related U.S. Application Data
(60) Provisional application No. 60/253,790, filed on Nov. 29, 2000.

(51) Int. Cl. G02B 6/35; G02B 6/28

(52) U.S. Cl. 385/17; 385/16; 385/24

(57) ABSTRACT

A network of inter-connectable optical fibers equipped, at strategic locations, with devices that can respond to optical signals emanating from a particular source as part of a message or data stream to determine the destination and select suitable fibers to assure its arrival at the point of destination, using at said locations lambda-extractor switches for single frequencies to signal the switching logic, nanosecond responsive switches to re-direct the data flow into appropriate other optical fibers on an instantaneous time basis, and massive cross-connecting switches that enable the connection to any incoming fiber to any outgoing fiber within one module in a mechanically asynchronous manner.

### RELATED APPLICATION

The present application claims the benefit of Provisional Application Serial No. 60/253,790, filed on Nov. 29, 2000.

### BACKGROUND OF THE INVENTION

1. Field of the Invention

This invention relates to a communications network. It relates especially to an optical communications network and to optical switching apparatus therefor.

2. Description of the Prior Art

In commercial optical communications networks and systems, the data acquired optically as light pulses at sending locations in one city or cities is often converted to electronic data streams for transmissions to selected receiving locations in another city or cities where the information is converted back to light pulses. It would be desirable to be able to send messages and other data from one location to another on a purely optical basis

### SUMMARY OF THE INVENTION

Accordingly it is an object of this invention is to provide a system which recognizes optical information sent by a source and translates this information into geometric cross-switching positions in a network that enables the data flow to be directed towards a selected destination and, when the connecting path is established, enabling the flow of the data to that destination on a purely optical basis.

Another object of the invention is to provide a fiber network which carries in optical form, using designated frequencies, the signals that enable the proper switching, while in the same fibers, using different frequencies, carrying the information flow.

A further object of the invention is to provide a network in which the address information is extracted and isolated from the main data stream so as to enable the setting of optical switches for connecting incoming fibers to outgoing fibers via resonant cavities, polarization switches, and/or omni-directional cross switches.

Another object of the invention is to provide a network which aims multiple, tiny laser beams across a space into multiple directions transmitting simultaneously from sending fibers to receiving fibers wherever they may be located in a network.

Another object of the invention is to provide for each sending fiber a rotatable oculus (eye) to which the incoming fiber is flexibly connected. In said oculus, a laser beam arriving in the fiber is collected by a micro-lens with the help of which said beam becomes collimated that so it emerges from the oculus as a micro-size, coherent light beam that can be aimed at a desired receiving fiber whose location is selectively situated within an X/Y matrix spaced from the oculus.

Another object of the invention is to provide movable oculi which can sweep a matrix of sites and stop at a selected location in an X/Y matrix. A specific requirement to be satisfied is that the sending oculus, when properly positioned, is met by an equally positioned, corresponding receiving oculus.

A related object of the invention is to provide a corrective subsystem for each oculus to assure, via feedback, the perfect aim of a sending laser beam onto the working end of the receiving oculus.

A further object of the invention is to provide apparatus which steps an oculus line by line in the up and down as well the left and right directions and stops at an electrically created position angle.

A further object of the invention is to provide a planar matrix full of oculi all of which can independently aim in different directions so as to enable the cross-connectability from any sending fiber to any receiving fiber, or multiple sending fibers to any one receiving fiber.

The invention accordingly comprises the features of construction, combination of elements and arrangement of parts which will be exemplified in the following detailed description, and the scope of the invention will be indicated in the claims.

Briefly, a modem photonic communication system has been devised based on an optical signaling capability, the use of optical fibers and photonic switches in which the information that is being transmitted is preceded by designated frequencies that identify the area code, city code and telephone number, followed by other frequencies flowing over the same fiber to transmit information, such as voice, digital data, or wide bandwidth video data. Since, especially in large cities, numerous incoming fibers will converge, all carrying different information (even though they may utilize the same frequencies), it is necessary to be able to cross-connect the appropriate fibers leading to other cities and destinations as chosen by the transmitting party. In other words, an optical data stream traveling in one fiber is connectable to another destination-specific optical fiber. The set-up time for these connections is minimal and, in some cases, achieved in a nano-second activation time.

Described below and three cross-switching techniques that will allow one to connect a source to any designated reception point within the network territory .The first type of switch serves as a “lambda extractor” that sets spatial photonic switches which reach the area, the city, and the final point of destination. The second type switch allows the redirection of the data flow in the network during transmission to an alternate route in nanosecond time causing essentially no disruption. The third type of switch enabling the novel network is an “omni-cross switch” that facilitates the cross connection of numerous incoming fibers to numerous outgoing fibers in a mechanically asynchronous manner.

A significant objective of this invention is to be able to instruct properly the switches along the way to which fiber the information is supposed to flow. This intelligence is provided by certain dedicated optical frequencies, say, 0 through 9, which are fed to the switches optically and are there translated to geometric code so as to gain access to designated fiber locations in a network. This feature is important because it allows the addressability of each sending fiber by any receiving fiber. Thus, a microprocessor (whether optical or electronic) and the electrical power needed to operate it are merely peripheral accessories that enable the correct cross switching of the information once it starts flowing in the network. Once the optical cross connect is established, the information from the sender to the recipient will flow in purely optical form and not be subject to optical-electronic-optical conversion as utilized in present communication systems.

Thus, this invention provides a fiberoptic network in which the information packet is “smart”, causing a series of photonic switches to respond to frequency codes that precede the information, but are part of the transmission, so as to direct the flow of the information from fiber to fiber and seek out the various levels of destination (area, city, office) until the ultimate destination is reached and the information transmission is completed.

### BRIEF DESCRIPTION OF THE DRAWINGS

For a fuller understanding of the nature and objects of the invention, reference should be made to the following detailed description taken in connection with the accompanying drawings, in which:

FIG. 1 is a schematic view of an optical transmission network embodying our invention;

FIG. 2A is a longitudinal cross-sectional view of an optical signal extractor used in the FIG. 1 network;

FIG. 2B is an exploded perspective view of parts of the FIG. 2A extractor;

FIG. 3 is a schematic diagram of a nanosecond optical switch used in the FIG. 1 network, and

FIG. 4 is a schematic diagram showing the operation of the FIG. 3 switch.

### DESCRIPTION OF THE PREFERRED EMBODIMENT

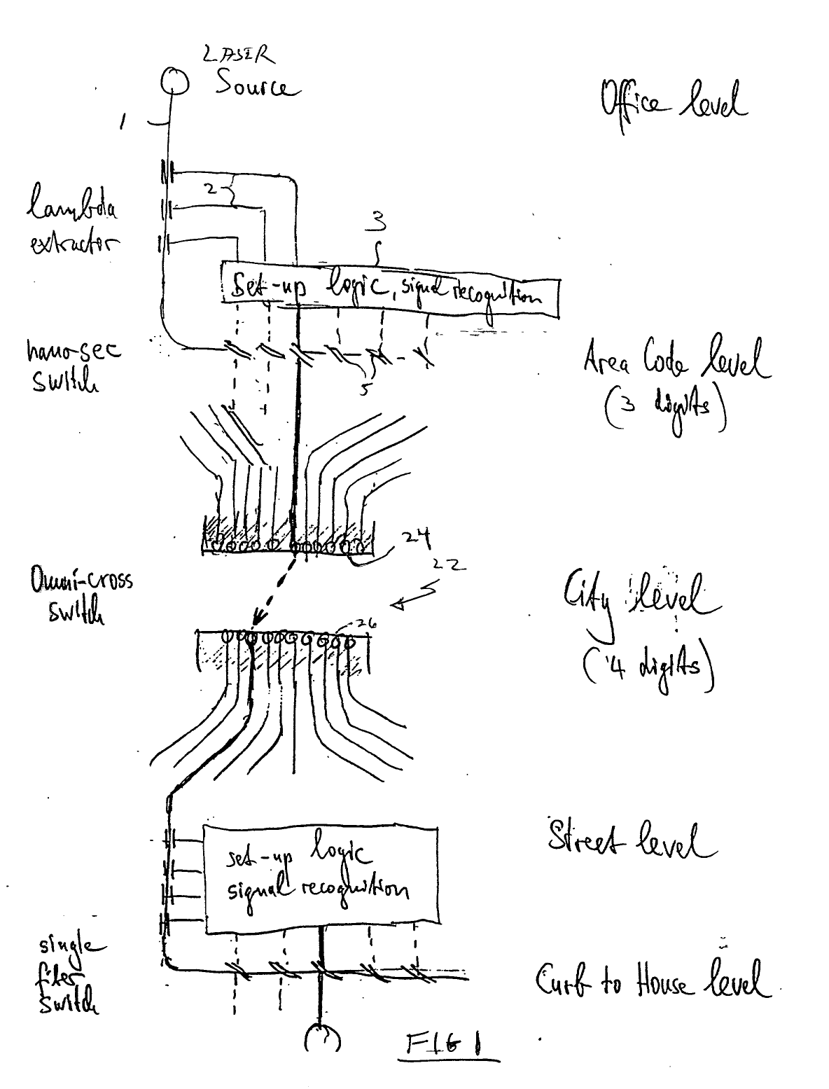

As shown in FIG. 1, for the network to operate, it must contain, at various cross-over points, suitable intelligent switches that can recognize the “signal frequencies” which trigger and set the switches which connect the appropriate fibers in the network.

Accordingly, the network includes a lambda extractor 10 which is able to extract a singular signal frequency and feed it to a logic circuit 3 via its own short optical fiber 1. With several singular, unique frequencies derived from the sending fiber 1 and fed, in parallel, to the logic circuit, the proper receiving fiber 2 can be selected which will be connected to the sending fiber 1 to pass on the information (voice, data, video) towards its ultimate destination. For example, if the code signals 6-1-7 were contained as a header in the data stream in the sending fiber 1, then the logic circuit will select and activate the switch 5 that connects the sending fiber to receiving fiber 2 for the 617 area code (Boston) and thus direct the data flow towards Boston.

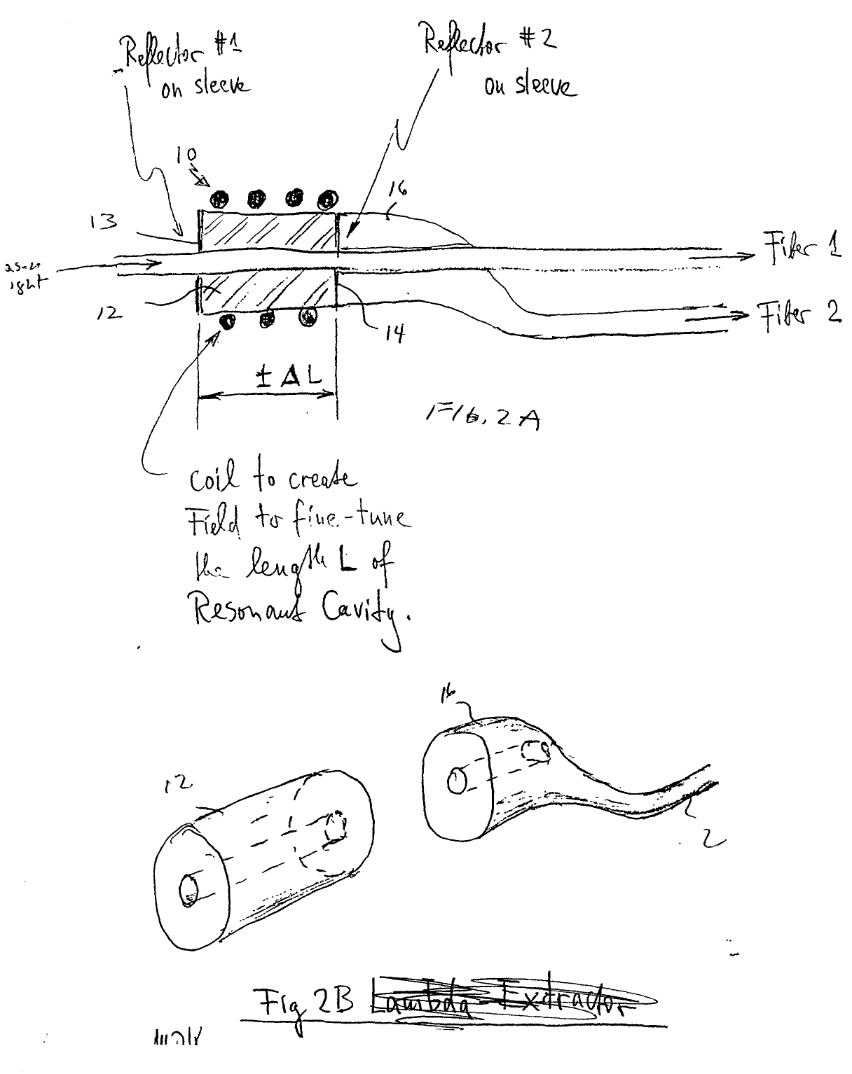

The lambda tuned extractor 10 shown in FIGS. 2A and 2B includes a cylindrical resonant cavity 12 having end mirrors 13 (full) and 14 (partial) and that surrounds the sending fiber I so it can interact with the evanescent waves which envelop that fiber. These waves will resonate in the cavity 12, building up energy, and exit through the partially transparent mirror 14 into the glass fiber stem 16 which surrounds the naked fiber. The length of the cavity 12 for λ of 1.55 μm is 0.3 mm.

To maintain resonance conditions, even though the laser source may drift in frequency, the lambda extractor 10 is equipped with frequency sensing capability as well as a magneto strictive length modulation feature to maintain the precise 0.3 mm cavity length plus the Δλ variation. The feedback from the sensor, the field generation, and the index of refraction compensation require monitoring of the light amplitude so as to retain optimum operating conditions.

The geometric features call for a first fiber 1 that has been stripped of its cladding. This first fiber is inserted into a ring-like stem 16 of a second fiber 2 whose polished end face is in contact with the stubby, 0.3 mm long cavity shell 13 which surrounds the first fiber 1 with a tight fit (i.e., shrinked on).

Thus, the first fiber 1, after the stubby shell 13, blends into a second fiber 2 via the ring-like stem 16 to forward the emitted light into the second fiber 2. Of course, only one single wavelength will be extracted and forwarded by a particular extraction device. Many serial extractors 10 tuned for different frequencies can follow each other along fiber 1, thus extracting as many single frequencies as desired or available.

In FIG. 1, the switches 5 enable the network to connect to the appropriate fibers. This device, controlled by the optical signal-responsive logic 3, can be turned on or off using polarized light and Brewster Angle reflector mirrors. The switching action is so fast that the data flow can be switched in mid stream without noticeable disruption.

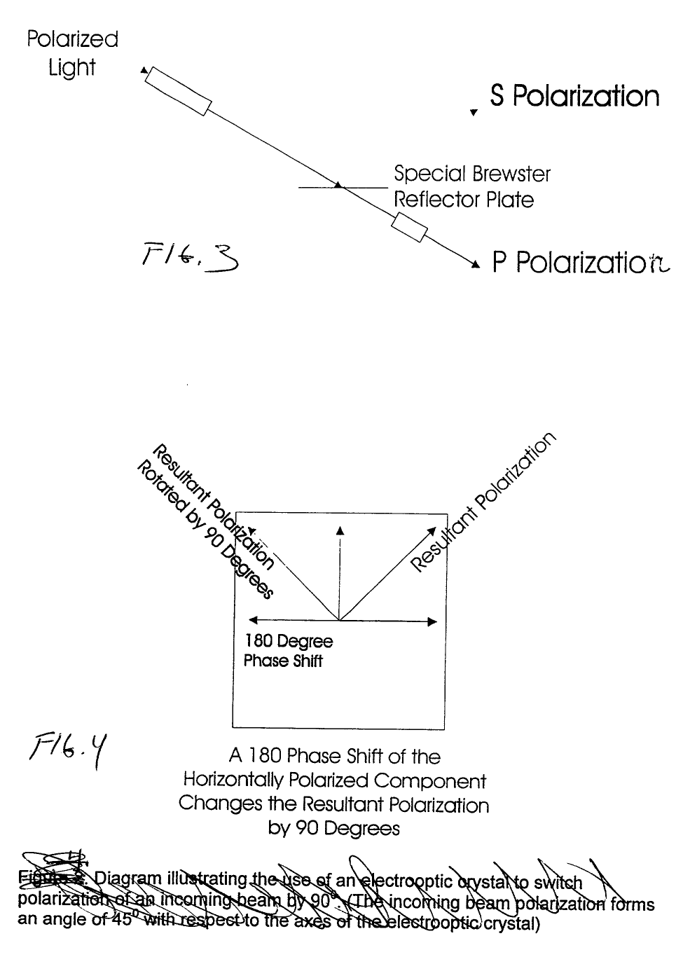

FIG. 3 shows schematically an optical switch 5 based on the Brewster Angle. An optical fiber may not present polarized light to the input of a switch 5. One can select one polarization for switching or one can separate the two polarizations and switch them separately before combining them again. In the switch 5 the light first enters a polarization rotator. Basically only a 90° degree polarization rotation is needed for changing the exit port of the light. Thus, one can simply use an electrooptical material, such as LiNbO₃, to accomplish this task by inducing through an electric field a relative phase shift of 180° between the two polarizations.

The Brewster Angle θ is defined as that angle of incidence at which p- polarized light will have no reflection when entering and exiting the reflector plate. If n_{B} is the index of refraction of this plate then

tan θ=n_{B}

For s polarization there will however be a strong reflection. By choosing a material with a high index, this reflection will be stronger. Silicon has an index of refraction of 3.346 at 1.55 micrometer. The corresponding Brewster Angle is 73.360°. There is zero reflection and 100% transmission for p- polarized light. S- polarized light will be reflected but a small amount will also go through the plate. The thickness of the Si plate can be chosen such that the reflections at the top and bottom of the plate interfere constructively. A reflection of 96.85% is achieved with a Si plate thickness of 0.122 μm. By using two plates of thickness 0.122 μm, and separated by about 1.25 μm this reflection increases to 99.974%. For two plates, the amount of s- polarized light transmitted will be 0.5%. If one desires a higher degree of suppression of transmitted s- polarization a third plate can be used or a blocking filter for s-polarization can be added. The small Brewster plates can be made by conventional deposition techniques using an easily dissolvable intermediate layer.

FIG. 4 diagram illustrates the use of an electrooptic crystal to switch polarization of an incoming beam by 90°. (The incoming beam polarization forms an angle of 45° with respect to the axes of the electrooptic crystal) Various combinations of platelets and polarization filters can be employed depending on the system requirements.

Thus it is possible to achieve an almost totally lossless optical switch which transmits in one direction or the other with no leakage into the undesired direction. This is accomplished with no moving parts. The switching speed is simply limited by the electronics applying a voltage to the polarization switching electrooptic crystal.

At major points of fiber convergence, typically in a city, the network includes an “omni-cross-switch” shown generally at 22 in FIG. 1. For example, there may be 999 fibers arriving from various diverse origins whose data streams must be directed towards other fibers to reach each point of destination. Switch 22 allows the cross-connection of any sending fiber to a receiving fiber by means of precise laser beam projection, as described below.

One of the requirements in a massive optical fiber network is to control the direction of the data flow by cross-connecting numerous designated fibers. The connections required will change from time to time, so the data flow from many input points will arrive at their individual output destinations as intended and be received without errors. The ability to redirect the flow of optical data from any incoming fiber to any other outgoing fiber so that the light beams can criss-cross each other in one central space or even merge multiple inputs to one or several output fibers, is the technical goal of the Omni-Cross-switch 22.

The set-up time for these cross connections is not critical because this is done before the data flow begins (optical dial-up). A set-up time of one to even 10 milliseconds will suffice.

Instead of using a multitude of delicate mirrors in the network, we have chosen the direct projection of collimated light beams, across a space, to achieve the coupling of the incoming data flow between select corresponding fibers.

This OPIX approach contains numerous advantages over mirrors, to wit:

the quality issue of mirror surfaces is eliminated,

the manufacturability problems of undercut mirrors and its associated costs are avoided,

the need to achieve perfect tilt angles without positional creep is diminished, and

we utilize the ideal elastic behavior of glass fibers to achieve adjustable directional aiming of the direct light beams.

The scalability of the disclosed cross-over switch is linear so that 999 fibers incoming to 999 fibers outgoing becomes a straightforward assembly issue. There is an old fascination with “no moving parts” devices. Yet construction of a large cross-switch with “N” fibers does not require the use of N² of these elementary switches, as is the case with MEMS devices. Thus there is a lot to be said for omni-switch-like components, as, numerous demanding tasks are reliably accomplished using numerous moving components.

The switch 22 employs on movable, friction-less component for each flexing fiber to achieve the direct projection of the collimated laser beamlets onto the receiving fiber ends. This creative approach results in simplicity, reliability, and lower manufacturing cost.

Assuming a matrix of 33×33=999 incoming fibers in a square bundle arriving at the switching plane 24 with each fiber having a 1 mm pitch, then the dimension of this square block is 33×33 mm. By placing the outgoing fibers 100 mm away in receiving plane 26, the angular coverage between the two planes requires a maximum tilt angle of 18.26°. Fibers have finite angles of acceptance for incoming light. Since the fiber cladding has an index that is only smaller by about 1% relative to the core index the acceptance angle is of the order of ±8°. We would exceed this acceptance angle by a tilt angle of our projecting optics of ±18°. We must also consider that the cone angle of the light produced by the focusing lens at the receiving fiber is also limited by the ±8°. To accommodate these requirements we plan to use rot table optics so that the sending and receiving optics directly look at each other with perpendicular exit and entrance beams. For the collimated beam diameter we chose a diameter of 1 mm.

The beam would expand because of diffraction in a distance of I=10 cm by λ/DI≈0.155 mm, where X is the wavelength, D is the beam diameter, and I the lens separation. Thus the light loss from spillover is slight. Also crosstalk is limited and can be further reduced by a slightly larger spacing of the fibers. The collimating lens at the receiving end needs to be able to focus the beam to a diameter of the order of the core diameter of the fiber or about 8 mm. This means that the focal length needs to be f=3.56 mm or larger (numerical aperture of 0.139) in order to accommodate the maximum light acceptance angle of the fiber. The diffraction limited spot size is then about (equation F˜5.5 mm), which accommodates the assumed 8 mm core diameter.

Now, with the exit pupils of the incoming fibers at plane 22 being movable, sweeping to any point within the angle of 20° to reach plane 24, the angle of incidence on the fiber ends on plane 26 never exceeds 20°. This is important because 27° would exceed the allowable angle of incidence.

The geometry of plane 26 not on reduces the angle of incidence to zero, but it also makes room between the individual fibers to place position-sensing marks that will provide feedback verification regarding the accurate placement of the multiple beams. This is done via tin rings of upconverting phosphors that are printed around each fiber location that are illuminated via co-parallel light with the primary laser beam lets that will assure, if not lit up, the precise alignment of the beamlet to the outgoing fiber core. A vidicon tube will automatically inspect the absence of aberrant illumination. Alternate feedback methods are also being considered.

As stated above, the oculi and their pupils at plane 22 are controllably movable, emitting collimated beamlets of light of typically 5 mm diameter. The oculi feature small spherical lenses that are inserted into X/Y moving spheres whose position is controlled via feedback using simple electro-strictive members.

The face plate on plane 24 is of split design to allow the insertion, retention, and movability of the oculi. The culottes (half-spheres) in each plate contain electro-strictive linings that allow the continuous adjustment in the X/Y planes, actually gripping the oculus surface to keep them in position.

1. A network of inter-connectable optical fibers equipped, at strategic locations, with devices that can respond to optical signals emanating from a particular source as part of a message or data stream to determine the destination and select suitable fibers to assure its arrival at the point of destination, using at said locations
a. lambda-extractor switches for single frequencies to signal the switching logic;
b. nanosecond responsive switches to re-direct the data flow into appropriate other optical fibers on an instantaneous time basis;
c. massive cross-connecting switches that enable the connection to any incoming fiber to any outgoing fiber within one module in a mechanically asynchronous manner.

2. The network according to claim 1 in which the message to be sent is preceded by optical code signals that identify the destination causing the setting up of the appropriate photonic switches to connect the incoming fiber to the relevant outgoing fiber using the switch configuration and network architecture described herein.

3. The network according to claim 1 wherein a lambda extractor device that is able to extract individual single frequencies from a glass fiber that carries many frequencies in parallel, said single frequency being useful, as part of other single frequencies, to operate a logic circuit which sets the photonic switches according to claim 2.

4. The network according to claim 1 wherein the nanosecond switch for optical data streams operates with polarized light and Brewster Angle reflection or transmission in accordance with the polarity of the incoming and/or outgoing light.

5. The network defined in claim 1 wherein each of said cross switch connect any incoming fiber in a given space to any outgoing fiber in said space using optical projection between designated, switchable fibers.

6. A method of achieving cross-switching of optical signals from various fiber ends to other various fiber beginnings, which method features a space across which the optical signals are transmitted, that method allowing any X/Y location within a matrix pattern to be addressed by obliquely aimed laser beams converting said space to achieve an optical connection between input and output.

7. A cross-connecting switch which operates according to the method defined in claim 11 whereby said switch feature two planes in juxtaposition, with light beams traversing said space from a first plate aiming at a second plate, with said first plate possessing one or more fiber entries, at the end of which at each location a tiltable mini lens is mounted whose position is controllable to aim at any X/Y point in the second plate across the intervening space so as to project a coherent laser beam across that space where collector lenses at each fiber end take the incoming light at the specific respective fiber at which it is aimed in order to convey the data stream represented by the light to a new outgoing station.

8. A cross-connect optical switch to achieve individual cross communications traversing said space from one incoming fiber, or any number thereof, to a second fiber, or any selected number thereon, on the second plate, with aid light beams being able to criss-cross each other in the space between the plate so as to simultaneously cross-connect optical data points for the purpose of sending them on their way to their respective destinations.

9. A network according to claim 1 including means for aiming the light beams using optical signals of pre-selected frequencies that contain the switching information necessary to be able to cross-connect from the entry position in name one to the exit position in name two, with said frequencies being extracted from the respective fibers via resonant couplers and then submitted to photo resistors and microprocessors which translate the incoming signals to the geometric X/Y position at which the incoming beams must be aimed.

10. A network according to claim 2 including a plate one and a plate two contained in a module or package with the fibers ending on plate one each being connected to its own little oculus which is tiltable in the vertical and in the horizontal direction so its exiting, collimated laser beam can be aimed at a selected location on plate two where a collector lens receive the laser beam and enters it into the outgoing fiber to send it on its way towards its destination.

11. A network according to claim 2 into which many fibers are inserted with each fiber ending in an oculus so as to create a plate in which many oculi can individually be rotated and tilted so as to feature a criss-crossing of invisible laser beams across a space providing photonic coupling without first pre-converting to electrons and then generating photons, with said oculi enabling the criss-crossing of photonic information from one plane to another plane by aiming said oculi in various, independently selectable positions.

12. A network lens according to claim 2, wherein within the spherical body of oculus is a minlens that collects the light exiting from the fiber that is tied to the end of the oculus and from there funneling the collected light towards a collimator lens so as to generate a parallel laser beam output whose direction can aim transversely across a space at a selected collector, lens with the distance from the oculus to said collector lens being o no consequence since the laser beam is parallel by nature and tiny in diameter without being affected by dispersion events.

13. A network as described in claim 1 where an incoming fiber carries two types of information, with the first information representing the switching instructions for the oculi and the other frequencies being operative to convey information such as speech or data or video information, said system flowing the cross connection from a first area of activity to a second area of activity, with the cross switch being the crucial element in the system because of its ability to route information to its various points of destination and to do so by purely optical means.

14. An oculus consisting of a spherical shape preferably made of glass that can rotate like an eyeball in its socket, with said glass containing an equatorial electrode on its outside that is able to interact wit a variety of electrodes inscribed in the holding plate so as to allow, when activated, to tilt the oculus up or down or left and right to aim it an X/Y location across the space using these fine electrode gratings to cause the adjustment of the oculus position through electrical attraction or other means in accordance with an entry signal.
